(19) United States
(12) Patent Application Publication
(10) Pub. No.: US 2015/0375211 A1
(43) Pub. Date: Dec. 31, 2015

(54) Potassium-doped Ni-MgO-ZrO2 catalysts for dry reforming of methane to synthesis gas

(71) Applicant: Neemo Inc., Hamilton (CA)

(72) Inventors: Julian R.H. Ross, Galway (IE); Bhari Mallanna Nagaraja, Bangalore (IN); Dmitri A. Bulushev, Novosibirsk (RU)

(21) Appl. No.: 14/754,670

(22) Filed: Jun. 29, 2015

Related U.S. Application Data
(60) Provisional application No. 62/018,213, filed on Jun. 27, 2014.

(51) Int. Cl. B01J 23/78; B01J 37/06; B01J 37/08; B01J 37/02

(52) U.S. Cl. CPC B01J 23/78; B01J 37/0207; B01J 37/0236; B01J 37/06; B01J 37/08

(57) ABSTRACT

The invention provides a method for the production of a supported nickel catalyst in which the support is prepared from mixed oxides preferentially comprising MgO, ZrO₂, and combinations thereof, in which the support is precipitated or co-precipitated by an aqueous, alkali-metal containing aqueous solution. The resulting nickel catalyst has good activity for the reforming of methane, and shows good stability and resistance to deactivation due to carbon deposition.

This application claims priority based on provisional application Ser. No. 62/018,213, filed Jun. 27, 2014, the contents of which are incorporated by reference in their entirety.

### REFERENCES CITED

U.S. Patent Documents

| | | |
|---|---|---|
| 2,575,324 | November 1951 | Shapleigh |
| 3,436,358 | April 1969 | Thygesen |
| 3,650,713 | March 1972 | Chinchen and Hicks |
| 3,759,678 | September 1973 | Chamberland et al. |
| 3,840,356 | October 1974 | Bernusset et al. |
| 3,945,944 | March 1976 | Kang |
| 3,988,262 | October 1976 | Andersen et al. |
| 4,469,815 | September 1984 | Sambrook et al. |
| 5,767,040 | June 1998 | Bhattacharyya et al. |
| 5,939,353 | August 1999 | Bhattacharyya et al. |

### OTHER REFERENCES

Aramendia, M. A., Borau, V., Jimenez, C., Marinas, A., Marinas, J. M., Navio, J. A., Ruiz, J. R. & Urbano, F. J. (2004) Synthesis and textural-structural characterization of magnesia, magnesia-titania and magnesia-zirconia catalysts. Colloids and Surfaces a-Physicochemical and Engineering Aspects, 234(1-3), 17-25.
Asencios, Y. J. O. & Assaf, E. M. (2013) Combination of dry reforming and partial oxidation of methane on NiO—MgO—ZrO2 catalyst: Effect of nickel content. Fuel Processing Technology, 106, 247-252.
Asencios, Y. J. O., Nascente, P. A. P. & Assaf, E. M. (2012) Partial oxidation of methane on NiO—MgO—ZrO2 catalysts. Fuel, 97, 630-637.
Barroso-Quiroga, M. M. & Castro-Luna, A. E. (2010) Catalytic activity and effect of modifiers on Ni-based catalysts for the dry reforming of methane. International Journal of Hydrogen Energy, 35(11), 6052-6056.
Bellido, J. D. A., De Souza, J. E., M′Peko, J. C. & Assaf, E. M. (2009) Effect of adding CaO to ZrO2 support on nickel catalyst activity in dry reforming of methane. Applied Catalysis a-General, 358(2), 215-223.
Bond, G. C. & Sarsam, S. P. (1988) Reduction Of Nickel Magnesia Catalysts. Applied Catalysis, 38(2), 365-377.
Borowiecki, T. (1984) Nickel-Catalysts For Steam Reforming Of Hydrocarbons—Phase-Composition And Resistance To Coking. Applied Catalysis, 10(3), 273-289.
Chen, Y. G., Tomishige, K., Yokoyama, K. & Fujimoto, K. (1999) Catalytic performance and catalyst structure of nickel-magnesia catalysts for CO2 reforming of methane. Journal of Catalysis, 184(2), 479-490.
Fan, M. S., Abdullah, A. Z. & Bhatia, S. (2010) Utilization of greenhouse gases through carbon dioxide reforming of methane over Ni—Co/MgO—ZrO2: Preparation, characterization and activity studies. Applied Catalysis B-Environmental, 100(1-2), 365-377.
Frusteri, F., Spadaro, L., Arena, F. & Chuvilin, A. (2002) TEM evidence for factors affecting the genesis of carbon species on bare and K-promoted Ni/MgO catalysts during the dry reforming of methane. Carbon, 40(7), 1063-1070.
Fujimoto, K., Tomishige, K., Yamazaki, O, Chen, Y. G. & Li, X. H. (1998) Development of catalysts for natural gas reforming: Nickel-magnesia solid solution catalyst. Research on Chemical Intermediates, 24(3), 259-271.
Garcia, V., Fernandez, J. J., Ruiz, W., Mondragon, F. & Moreno, A. (2009) Effect of MgO addition on the basicity of Ni/ZrO2 and on its catalytic activity in carbon dioxide reforming of methane. Catalysis Communications, 11(4), 240-246.
Gocmez, H. & Fujimori, H. (2008) Synthesis and characterization of ZrO2-MgO solid solutions by citrate gel process. Materials Science and Engineering B-Advanced Functional Solid-State Materials, 148(1-3), 226-229.
Horiuchi, T., Sakuma, K., Fukui, T., Kubo, Y., Osaki, T. & Mori, T. (1996) Suppression of carbon deposition in the CO2-reforming of CH4 by adding basic metal oxides to a Ni/Al2O3 catalyst. Applied Catalysis a-General, 144(1-2), 111-120.
Hu, Y. H. & Ruckenstein, E. (1997) The characterization of a highly effective NiO/MgO solid solution catalyst in the CO2 reforming of CH4. Catalysis Letters, 43(1-2), 71-77.
Juan-Juan, J., Roman-Martinez, M. C. & Illan-Gomez, M. J. (2006) Effect of potassium content in the activity of K-promoted Ni/Al2O3 catalysts for the dry reforming of methane. Applied Catalysis a-General, 301(1), 9-15.
Juan-Juan, J., Roman-Martinez, M. C. & Illan-Gomez, M. J. (2009) Nickel catalyst activation in the carbon dioxide reforming of methane Effect of pretreatments. Applied Catalysis a-General, 355(1-2), 27-32.
Kim, J. H., Suh, D. J., Park, T. J. & Kim, K. L. (2000) Effect of metal particle size on coking during CO2 reforming of CH4 over Ni-alumina aerogel catalysts. Applied Catalysis a-General, 197(2), 191-200.
Koubaissy, B., Pietraszek, A., Roger, A. C. & Kiennemann, A. (2010) CO2 reforming of methane over Ce—Zr—Ni-Me mixed catalysts. Catalysis Today, 157(1-4), 436-439.
Lee, M. H., Tai, C. Y. & Lu, C. H. (1999) Synthesis of spherical zirconia by precipitation between two water/oil emulsions. Journal of the European Ceramic Society, 19(15), 2593-2603.
Li, X. S., Chang, J. S., Tian, M. Y. & Park, S. E. (2001) CO2 reforming of methane over modified Ni/ZrO2 catalysts. Applied Organometallic Chemistry, 15(2), 109-112.
Mercera, P. D. L., Vanommen, J. G., Doesburg, E. B. M., Burggraaf, A. J. & Ross, J. R. H. (1991) Zirconia As A Support For Catalysts—Influence Of Additives On The Thermal-Stability Of The Porous Texture Of Monoclinic Zirconia. Applied Catalysis, 71(2), 363-391.
Meshkani, F. & Rezaei, M. (2011) Nickel catalyst supported on magnesium oxide with high surface area and plate-like shape: A highly stable and active catalyst in methane reforming with carbon dioxide. Catalysis Communications, 12(11), 1046-1050.
Montoya, J., Romero, E., Monzon, A. & Guimon, C. (2000). Studies in Surface Science and Catalysis, 130, 3669.
Nagaraja, B. M., Bulushev, D. A., Beloshapkin, S. & Ross, J. R. H. (2011) The effect of potassium on the activity and stability of Ni—MgO—ZrO2 catalysts for the dry reforming of methane to give synthesis gas. Catalysis Today, 178(1), 132-136.
Parmaliana, A., Arena, F., Frusteri, F. & Giordano, N. (1990) Temperature-Programmed Reduction Study Of Nio—Mgo Interactions In Magnesia-Supported Ni Catalysts And Nio-Mgo Physical Mixture. Journal of the Chemical Society-Faraday Transactions, 86(14), 2663-2669.
Pietraszek, A., Koubaissy, B., Roger, A. C. & Kiennemann, A. (2011) The influence of the support modification over Ni-based catalysts for dry reforming of methane reaction. Catalysis Today, 176(1), 267-271.
Ruckenstein, E. & Hu, Y. H. (1995) Carbon dioxide reforming of methane over nickel alkaline earth metal oxide catalysts. Applied Catalysis a-General, 133(1), 149-161.
Snoeck, J. W., Froment, G. F. & Fowles, M. (2002) Steam/CO2 reforming of methane. Carbon formation and gasification on catalysts with various potassium contents. Industrial & Engineering Chemistry Research, 41(15), 3548-3556.
Sun, L. Z., Tan, Y. S., Zhang, Q. D., Xie, H. J. & Han, Y. Z. (2011) Combined air partial oxidation and CO2 reforming of coal bed methane to synthesis gas over co-precipitated Ni—Mg—ZrO2 catalyst. International Journal of Hydrogen Energy, 36(19), 12259-12267.
Teterycz, H., Klimkiewicz, R. & Laniecki, M. (2003) The role of Lewis acidic centers in stabilized zirconium dioxide. Applied Catalysis a-General, 249(2), 313-326.
Tian, X. K., Zeng, Y. L., Xiao, T., Yang, C., Wang, Y. X. & Zhang, S. X. (2011) Fabrication and stabilization of nanocrystalline ordered mesoporous MgO—ZrO2 solid solution. Microporous and Mesoporous Materials, 143(2-3), 357-361.
Trakarnpruk, W. & Sukkaew, C. (2008) Preparation of Ni/MgOZrO2 nanocrystals by citrate sol-gel method. Journal of Alloys and Compounds, 460(1-2), 565-569.
Tsunekawa, S., Asami, K., Ito, S., Yashima, M. & Sugimoto, T. (2005) XPS study of the phase transition in pure zirconium oxide nanocrystallites. Applied Surface Science, 252(5), 1651-1656.
Wang, S. B., Murata, K., Hayakawa, T., Hamakawa, S. & Suzuki, K. (2001) Selective oxidation of ethane and propane over sulfated zirconia-supported nickel oxide catalysts. Journal of Chemical Technology and Biotechnology, 76(3), 265-272.
Xu, D. Y., Li, W. Z., Ge, Q. J. & Xu, H. Y. (2005) A novel process for converting coalmine-drained methane gas to syngas over nickel-magnesia solid solution catalysts. Fuel Processing Technology, 86(9), 995-1006.
Zhang, Z. L. & Verykios, X. E. (1994) Carbon-Dioxide Reforming Of Methane To Synthesis Gas Over Supported Ni Catalysts. Catalysis Today, 21(2-3), 589-595.

### FIELD OF THE INVENTION

The present invention relates to a methane reforming catalyst based on supported nickel, a method for making a supported nickel catalyst, and supported catalysts obtained by said method.

### BACKGROUND OF THE INVENTION

Methane reforming processes involve the conversion of methane into other gases typically comprising carbon monoxide, hydrogen, and carbon dioxide. The temperature range for methane reforming is normally in the range of 400-1300° C. Most currently available methane reforming catalysts have good methane conversion rates at higher reaction temperatures (e.g. at 600° C. and above). On the other hand, most currently available methane reforming catalysts suffer from catalyst deactivation over time. The biggest cause of deactivation is due to the accumulation of carbon on the catalyst surface. To overcome this limitation of conventional reforming catalysts, methane reforming is normally practiced under conditions involve approximately 3:1 molar ratios of steam to methane. This practice is known as steam reforming. The inclusion of steam in the reforming process changes the process thermodynamics sufficiently that carbon accumulation on the catalyst is reduced. For the last 20 years, catalyst researchers have devoted great efforts to developing highly active and stable catalysts that are resistant to carbon deposition. Most of these efforts have not yet yielded a commercially available catalyst that has the desired characteristics with respect to activity, stability, and resistance to carbon deposition.

The problem of carbon deposition is particularly marked for Ni catalysts, and hence much work has therefore been devoted to the development of supported noble metal catalysts (Rh, Ru, Ir, Pt and Pd) for which the problem of carbon deposition is less marked. However, due to the fact that Ni is much cheaper than are the noble metals, much research is still being carried out to try to find a stable Ni-based material for the reaction. It has been demonstrated very clearly for Ni-based catalyst that both the catalytic activity and the extent of carbon formation depend on the nature of the support, the precursor of the active phase and the preparation method. It has been reported that MgO, TiO₂, ZrO₂ and La₂O₃ can all interact favorably with nickel in order to significantly inhibit carbon deposition on the catalyst surface and it has been suggested that it is important to have small Ni particles.

In 1995, Ruckenstein and Hu (Ruckenstein & Hu, 1995) reported results for catalysts consisting of NiO containing MgO, CaO, CrO or SrO, and showed that a NiO—MgO catalyst exhibited stable activity, this being due to the formation of a MgO/NiO solid solution. Since this promising result, a number of studies have looked at Ni-based catalysts that involve MgO, most of which include MgO in the support upon with the Ni active sites are added. These studies are summarized in Table 1.

TABLE 1
Ni-based catalysts involving MgO, ZrO₂, and K.

| | Catalyst | |
|---|---|---|
| | Compo- | |
| Reference | nents | Brief Description |
| (Xu et al, | Ni, MgO | Impregnation of Ni onto MgO powder |
| 2005) | | |
| (Meshkani & | Ni, MgO | Impregnation of aqueous Ni nitrate onto |
| Rezaei, 2011) | | MgO powder |
| (Ruckenstein | Ni, MgO | Impregnation of aqueous Ni nitrate onto |
| & Hu, 1995) | | MgO powder |
| (Hu & | Ni, MgO | Impregnation of aqueous Ni nitrate onto |
| Ruckenstein, | | MgO powder |
| 1997) | | |
| (Li et al, | Ni, MgO, | ZrO₂—MgO support prepared by sol-gel |
| 2001) | ZrO₂ | method. Ni nitrate impregnation onto |
| | | support. |
| (Asencios & | Ni, MgO, | Polymerization method. Made from |
| Assaf, 2013) | ZrO₂ | mixtures of Ni nitrate, Zr carbonate, |
| | | and Mg nitrate. |
| (Fan et al, | Ni, MgO, | Zr nitrate added onto MgO powder by |
| 2010) | ZrO₂ | incipient wetness technique. Then, Ni |
| | | nitrate impregnated onto MgO—ZrO₂ |
| | | support. |
| (Garcia et al, | Ni, MgO, | Co-precipitation of Zr⁴⁺ and Mg²⁺ cations |
| 2009) | ZrO₂ | into aqueous ammonia solution. |
| | | Impregnation of support by Ni aqueous |
| | | solution. |
| (Aramendia | Ni, MgO, | Sol-gel method using Mg nitrate, Zr |
| et al, 2004) | ZrO₂ | chloride and titanium oxide. |
| (Frusteri et al, | Ni, MgO, | K addition improves resistance of |
| 2002) | K | Ni—MgO to coking. Calcined catalyst is |
| | | impregnated by solution of K-acetate. |
| (Fujimoto et al, | Ni, MgO, | Co-precipitating Ni acetate and Mg nitrate |
| 1998) | K | aqueous solution with potassium carbonate |
| (Chen et al, | Ni, MgO, | Co-precipitating Ni acetate and Mg nitrate |
| 1999) | K | aqueous solution with potassium carbonate |
| (Nagaraja et al, | Ni, MgO, | Co-precipitation of Mg nitrate and Zr nitrate |
| 2011) | ZrO₂, K | to form support. Followed by impregnation |
| | | by KOH. Followed by impregnation by Ni |
| | | nitrate aqueous solution. |

In addition to including MgO in the catalyst, either in the support formulation, or in the active phase, other components have also been used or added in an effort to improve the resistance to carbon formation.

There has recently been significant interest in catalysts containing zirconia (i.e. ZrO₂). Zirconia exhibits the proportions of Lewis acidic and basic sites (Teterycz et al, 2003) as well as the redox properties of the resultant catalysts (Wang et al, 2001). It also has a substantial ionic conductivity due to its ability to form defects and surface oxygen vacancies. Further, zirconia has a high thermal and mechanical stability. Its properties have been shown to improve significantly when cations such as Y³⁺, La³⁺, Mg²⁺ and Ca²⁺ are added (Aramendia et al, 2004; Bellido et al, 2009; Lee et al, 1999; Mercera et al, 1991). Ni-based catalysts that include MgO and Zirconia, normally in the support material, are also included in Table 1.

The alkali metals (Li, Na and K) can also act as promoters or modifiers of catalysts based on different supports when used for the dry reforming of methane. Several authors have reported on the use of potassium-doped Ni based catalysts based on different supports (MgO, Al₂O₃, CeO₂, La₂O₃, ZrO₂ and MgO—ZrO₂) for the dry reforming of methane (Barroso-Quiroga & Castro-Luna, 2010; Frusteri et al, 2002; Juan-Juan et al, 2006; Nagaraja et al, 2011). In general, it has been found that the addition of small amounts of potassium (0.2-0.5 wt. %) gives catalysts with stable activity and very low tendencies to coke deposition.

Table 1 includes three studies, by Fujimoto et al, Chen et al, and Frusteri et al that include the addition of K in the catalyst formulation. In the work by Fujimoto et al and Chen et al, K carbonate was used as a precipitating agent in the preparation of a Ni—MgO solid solution, but the amount of K, if any, that remained in the final catalyst was not determined (Chen et al, 1999; Fujimoto et al, 1998). In the study by Frusteri et al, K was impregnated onto a Ni-MgO catalyst by addition of an isopropanolic solution of K acetate (Frusteri et al, 2002). A 0.125 ratio with Ni and the inclusion of K was noted to strongly improve the resistance of a Ni—MgO catalyst to carbon formation and to sintering.

To date, there has been no report of Ni-based catalyst on a Mg-containing support in which K, or other alkali metal, is directly integrated, or included, in the support preparation step. In the work by Fujimoto et al and Chen et al, K carbonate is used as the precipitating agent to produce a Ni-MgO solid solution catalyst, but there is no distinct MgO support preparation step in which K carbonate is used to precipitate the support. In the study by Frusteri et al, K is added to the MgO support by later impregnation. Similarly, in the 2011 study by Nagaraja et al, which was performed by our group, K was added to a MgO-ZrO2 support by impregnation at a later step (Nagaraja et al, 2011). The 2011 study by Nagaraja et al was the first to examine a catalyst that included Ni, MgO, ZrO₂, and K.

In the present invention, K is, for the first time, explicitly included in an MgO—K or MgO—ZrO₂—K support preparation step. This improvement not only simplifies the preparation of a Ni-based catalyst with high and stable methane reforming activity, but the present catalyst has a different surface chemistry than when K is added later to the catalyst support. Table 2 summarizes some of the surface chemistry differences between the catalysts described in Examples 1-8 of the present invention, and the catalyst described in the 2011 study by Nagaraja et al.

TABLE 2
Comparison of surface chemistry and component stoichiometry
between a catalyst from Example 1 of the present invention
and a catalyst from Nagaraja et al (2001).

| | | Ni/K—Mg5Zr2 |
|---|---|---|
| | 0.9K-NM5Z2 | catalyst from |
| | catalyst from | Example 1 of |
| | Nagaraja | the present |
| Catalyst | et al (2011) | invention |
| Ni weight % in catalyst | 7.6 | 9.1 |
| K weight % in catalyst | 0.92 | 0.95 |
| Brunauer, Emmett, and | 42 m2/g | 59 m2/g |
| Teller (BET) surface area of | | |
| catalyst | | |
| Atomic surface ratio, Ni/Mg | 0.044 | 0.01 |
| Atomic surface ratio, K/Mg | 0.004 | 0.004 |
| Atomic surface ratio, Zr/Mg | 0.01 | 0.03 |

### DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In contrast to problems associated with known reforming catalysts, the present invention provides a catalyst having high activity, high stability, and high yield of synthesis gas. The term synthesis gas, as used in this specification, includes carbon monoxide, hydrogen and gas mixtures containing carbon monoxide and hydrogen.

The catalyst is further differentiated from known reforming catalysts through the inclusion of alkali metal promoters and modifiers (e.g. K, Li, Na) in the catalyst formulation. Although such modifiers have been used in other catalyst formulations, they have not generally been used in combination with the remaining catalyst components of the present invention (e.g. in combination with Ni and Mg, or in combination with Ni, Mg, and Zr), and where they have, they have not been used in the preparation of the catalyst support material.

We are aware of only a single instance of prior art disclosing a reforming catalyst composition with similar components to those in the present invention. That instance was a publication by our own group in the journal Catalysis Today in 2011 (Nagaraja et al, 2011). The catalyst of the present invention is differentiated from that instance of prior art by the manner in which the particular components of the catalyst are assembled. In particular, in the present invention, a solution of akali metal salts is utilized as a precipitating agent to prepare the support, rather than have the alkali metal impregnated onto the support surface in a later step, as in the 2011 description. This difference results in a catalyst with different physicochemical properties than the catalyst described, as well as different molar ratios of the catalyst components on the surface of the catalyst (Table 2). The present invention is also differentiated from the work in 2011 through one embodiment of the invention which describes a catalyst comprising the components Ni, Mg, and K, but not Zr. In contrast, the catalyst of 2011 involved all of the components Ni, Mg, K, and Zr.

In the present invention, a catalyst support is first prepared. The support may be prepared by any suitable method involving the inclusion of the support components, including co-precipitation and sol-gel. The methods of homogeneous precipitation and impregnation for preparation of the support are excluded from the present invention, the former because it has not been demonstrated in the present invention, the latter because it was previously demonstrated in the prior art. Co-precipitation is the preferred methods for preparing the support material.

When using a co-precipitating method, one water soluble magnesium salt is dissolved in water. Optionally, one water soluble zirconium salt may be dissolved in the water together with the magnesium salt.

A precipitate is generated by adding a precipitation reagent to the above mixed aqueous solution. In a preferred embodiment, the precipitation reagent is added drop-wise to the aqueous solution at 333 K with constant stirring to maintain the pH value at about 9.5. However, in a less preferred embodiment, the precipitation reagent could be added to the aqueous solution without stirring and at higher or lower temperatures, including room temperature.

The precipitation reagent may be selected from OH— (hydroxide ion) and CO₃²⁻. Importantly, a salt of the precipitation reagent is dissolved in water, such that the salt includes an alkali metal such as Li, Na, and K, which is co-dissolved in the water. This important step enables the alkali cation to become integrated into the support during the co-precipitation. Sodium carbonate, sodium bicarbonate, sodium oxalate, sodium hydroxide, potassium carbonate, potassium bicarbonate, potassium oxalate, potassium hydroxide, lithium carbonate, lithium bicarbonate, lithium oxalate, lithium hydroxide and the like might be used as the precipitation reagent. Aqueous potassium carbonate is a preferred precipitation reagent.

As an alternative means to include an alkali metal in the support, the alkali metal can be dissolved as a water soluble salt together with the magnesium salt and the optional zirconium salt. In this case, the precipitation reagent does not need to be supplied as a dissolved salt of an alkali metal, although such a dissolved salt of an alkali metal can still be used. The precipitation reagent may be selected from NH⁴⁺, OH— (hydroxide ion), and CO₃²⁻. In the addition to the above mentioned list of precipitation reagents (including sodium carbonate, sodium bicarbonate, etc.), ammonium carbonate, ammonium bicarbonate, ammonia and the like can be used as the precipitation reagent when an alkali metal salt has already been included in the aqueous solution of dissolved salts.

The (co)precipitate is then cooled, if co-precipitation was performed at elevated temperature, and thoroughly washed. In a preferred embodiment, distilled water is utilized for the washing, and the (co)precipitate is filtered following washing. The resulting paste is then dried and calcined. In a preferred embodiment, the resulting paste is dried at 393 K overnight and calcining is at 1,073 K for 5 h in air. After the washing procedure, the alkali metal will remain in the sample. Further washing of the sample even with boiling water will generally not further reduce the content of alkali metal, indicating that it is well integrated into the MgO—K or MgO—ZrO₂—K support.

Nickel is next added to the support by any suitable method, including impregnation and sol-gel. Homogeneous precipitation is excluded from the group of suitable methods as it has not been demonstrated. Impregnation is the preferred method.

Calcined support is added to an aqueous solution of a nickel salt to give a final nickel weight percentage of 2-50%. In a preferred embodiment, the final nickel weight percentage is approximately 10%. In a preferred embodiment, the support is added with continuous stirring, the water is removed by evaporation on a hot plate and the residue was dried at 393 K overnight. Removal of water by filtration and drying by other means are all acceptable embodiments.

In a preferred embodiment, the Ni-containing sample is not calcined before being reduced prior to use. Samples can be calcined, but calcining in air at 1,073 K is observed to reduce catalyst stability and cause a loss in methane conversion activity over time on stream.

In a preferred embodiment, the Ni-containing catalyst is reduced at 1,023 K for 2 h in hydrogen prior to use.

### BRIEF DESCRIPTION OF THE DRAWINGS

The invention will now be described with respect to the drawings, wherein:

FIG. 1(a) Scanning TEM, and (b) Ni EDX mapping of the reduced Ni/K—Mg₅Zr₂ catalyst Some Ni particles are indicated by arrows.

FIG. 2 Schematic representation of the Ni/MgO—ZrO₂ catalyst characterization results.

FIG. 3(a) CH₄ conversion and (b) CO₂ conversion vs. temperature obtained in dry reforming of methane over the 10% Ni catalysts on different supports. (Reaction conditions: Catalyst: 20 mg, Reduction—1023 K/2 h, CH₄/CO₂/Ar ratio—1:1:8, total flow rate—50 ml/min).

FIG. 4 Stability tests comparing CH₄ conversion in dry reforming of methane over the catalysts reduced before the experiment. The Ni/K—Mg₅Zr₂(C) catalyst was calcined before the reduction and the Ni/K—Mg₅Zr₂ catalyst was not calcined. Temperature—1023 K, other conditions are the same as in FIG. 1.

FIG. 5 Stability tests comparing CH₄ conversion in dry reforming of methane over the 10% Ni catalysts on different supports at 1023 K. Reaction conditions are the same as in FIG. 1.

FIG. 6 Carbon deposition amounts related to the catalyst weight measured during dry reforming of methane over the 10% Ni catalysts on different supports. (Reaction conditions: Catalyst: 40 mg, Reaction temperature: 1023 K, CH₄/CO₂/N₂—1/1/8, Total flow rate—100 ml/min).

FIG. 7 Carbon deposition amounts related to the catalyst weight over the 10% Ni catalysts on different supports (a) in a CH₄/CO₂/N₂ mixture (1/1/8) for 240 min and (b) in a CH₄/N₂ mixture (1/9) for 60 min after (a). Catalyst: 40 mg, Reaction temperature—1023 K, Total flow rate—100 ml/min.

FIG. 8 X-ray difractograms of the reduced 10% Ni catalysts on different supports.

FIG. 9 TEM images of the reduced 10% Ni catalysts on different supports. (a) Ni/K—Mg and (b) Ni/K—Mg₅Zr₂.

### EXAMPLES

### Example 1

### Catalyst Preparation

The samples of MgO, ZrO₂ and mixed oxide supports used in the work presented here were prepared by precipitation or coprecipitation methods. Mg(NO₃)₂.6H₂O (purity, 99%) and ZrO(NO₃)₂.xH₂O (purity, 99.98%) were dissolved in distilled water and an aqueous solution of K₂CO₃ (1 M) (purity, 99%) was added drop-wise by appropriate mixture at 333 K with constant stirring to maintain the pH value at about 9.5. In all cases, the (co)precipitate was cooled and thoroughly washed with distilled water several times; it was then filtered and the resulting paste was dried at 393 K overnight and finally calcined at 1073 K for 5 h in air. After the washing procedure used, potassium (ca. 0.95 wt. %) still remained in all the samples. Attempts were made to reduce the K content of the samples by several cycles of washing the precipitates with boiling water, drying and rewashing again in boiling water; however, no change in the K content was found, the value remaining at ca. 0.95 wt. %.

The supported nickel catalysts were prepared by impregnation of the various supports using solutions of nickel nitrate. The appropriate weight of nickel nitrate needed to give about 10 wt. % nickel in the final reduced material was dissolved in a small amount of distilled water and the required amount of the calcined support was added with continuous stirring; the remaining water was removed by evaporation on a hot plate and the residue was dried at 393 K overnight. In the majority of the experiments reported in the examples, the Ni-containing samples were not calcined before reduction at 1023 K for 2 hours. However, for comparison, a portion of the Ni/K—MgO—ZrO₂ (mole ratio=5:2) material was calcined in air at 1073 K for 5 h, this being designated as Ni/K—Mg₅Zr₂(C). The catalysts without a calcination step were designated as Ni/K—Mg₅Zr₂, Ni/K—Mg₂Zr₅, Ni/K—Mg and Ni/K—Zr (see Table 3).

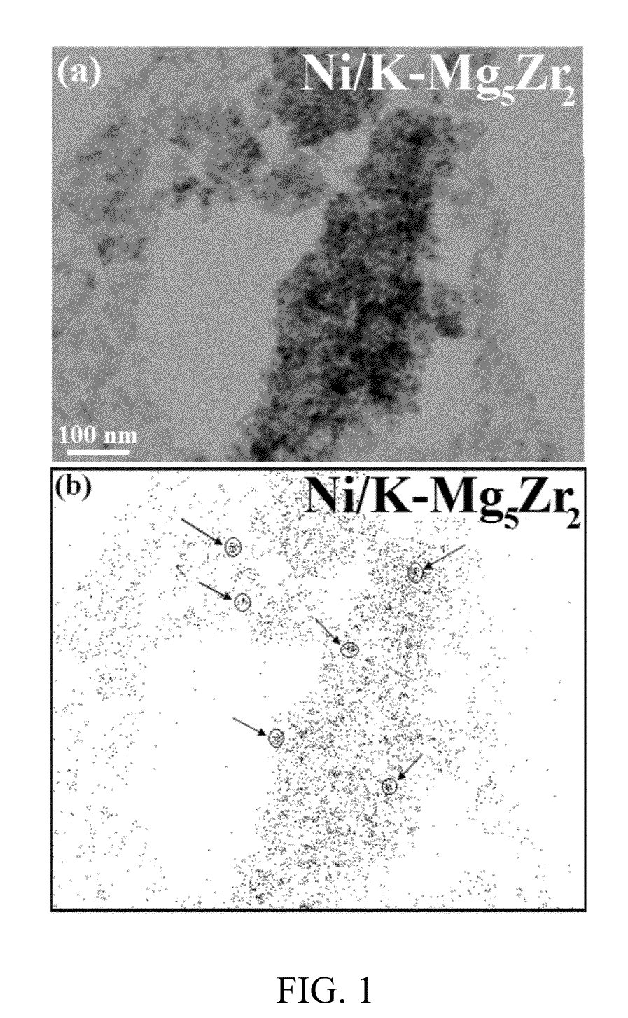

Catalyst samples described in the remaining examples, as well as in Tables 3-5, and FIGS. 1-9 refer to catalysts prepared according to Example 1.

### Example 2

### Characterization Methods

The BET specific surface areas of the materials were determined by using nitrogen adsorption at 77 K using a Micromeritics Gemini II 2370 surface area analyzer. Prior to the analyses, the samples were outgassed in a N₂ flow at 473 K for 2 h. Powder X-ray diffraction (XRD) patterns were measured on a Philips X'Pert PRO MPD system equipped with a rotating anode and using Ni-filtered Cu Kα radiation (λ=1.5418 Å).

H₂ pulse chemisorption experiments were carried out with a Micromeritics 2910 analyzer to obtain Ni surface area and dispersion. Before measuring the metal area by pulse chemisorption, the catalyst sample (>100 mg) was placed in a U-tube quartz reactor and reduced with a 15% H₂/Ar mixture using a flow rate of 30 ml min⁻¹; during the reduction, the temperature was ramped at 10 K min⁻¹ from room temperature to 1023 K and kept constant at that temperature for 2 h. After reduction, the catalyst was cooled to room temperature in pure argon; rapid cooling was achieved by flushing the surroundings with cooled nitrogen. Pulsing of a 15% H₂/Ar mixture to the reactor was then performed until no further adsorption of H₂ took place. The metal dispersion of each of the catalysts was then calculated from the amount of hydrogen adsorbed, taking the stoichiometry factor (SF) as two:

Dispersion(%)=100×Vs×SF×MW/(SW×Fn×22414)

where Vs is the cumulative volume of adsorbed H₂ (cm³ at STP), MW is the molecular weight of Ni metal (g mol⁻¹), SW is the weight of sample and Fn is the Ni fraction in relation to the total catalyst sample weight.

High resolution and scanning TEM images were taken with a JEOL JEM-2100F (200 kV) microscope. This instrument includes an X-ray energy dispersive spectrometer (EDAX) and high angle annular dark field scanning TEM detector (HAADF STEM). X-ray photoelectron spectroscopy (XPS) studies were performed with a Kratos Axis 165 spectrometer using a monochromatic Al Kα radiation (hv=1486.58 eV) and fixed analyzer pass energy of 20 eV. The potassium and Ni contents of the samples (Table 3) were determined by atomic absorption spectroscopy (AAS) following extraction with a diluted HCl:HNO₃ (3:1) mixture for 12 h.

### Example 3

### Activity Tests

The reaction was carried out at 823-1023 K at atmospheric pressure using 20 mg of the catalyst in a fixed bed quartz reactor of 4 mm internal diameter; the catalyst bed length between the quartz wool layers in the reactor was approximately 2-3 mm. Before each experiment, the sample was reduced in a 5% H₂/Ar flow, the temperature being increased slowly from room temperature to 1023 K and the final value being maintained for 2 h. The catalyst was then cooled to the lowest reaction temperature (823 K) in Ar before exposing it to a reaction mixture consisting of CH₄, CO₂ and Ar in the ratio of 1:1:8; the total flow rate was 50 ml min⁻¹. The reaction was carried out for 30 min at a succession of temperatures, in steps of 50 K, from 823 K to 1023 K; the behavior of the catalyst at the final temperature was then examined over a period of 14 h to check the stability of the catalyst. The product and reactants were analyzed by a micro gas chromatograph (Agilent-3000) equipped with two columns (Porapak Q and Molsieve 5A), each with a TCD detector.

### Example 4

### Carbon Deposition Studies

Carbon deposition under reaction conditions at 1023 K with a total pressure of 986.5 mbar was examined using a computer controlled microbalance system (Intelligent Gravimetric Analyser, IGA, Hiden). A dried sample of the catalysts to be studied (40 mg) was placed in a quartz basket. The samples were first reduced in 5% H₂/Ar at 1023 K for 2 h and then purged by N₂ for 30 min; the gas was then switched to a reactant stream containing CH₄, CO₂ and N₂ (molar ratio 1:1:8; total flow rate of 100 ml min⁻¹) for 4 h. In consequence, the contact times in the activity tests and the carbon deposition experiments were the same. Finally, for each sample, the CO₂ of the inlet gas was switched off and the experiment was continued for another hour with a CH₄/N₂ ratio adjusted to 1:9 (Total flow=100 ml min⁻¹). The weight changes and relative carbon contents of the samples were recorded by data acquisition software. The relative carbon contents reported below were calculated from the weight increases relative to the catalyst weights after reduction.

### Example 5

### Characterization Results

Table 3 shows details of the various catalysts prepared in the Example 1, the designations given in the first column including where appropriate the Mg/Zr atomic ratios as discussed in Example 1. The next two columns give the Ni and K⁺ contents of the samples; the Ni contents (calculated for a reduced material) all lie within the range 8.9 to 10.0 wt %. The supports were prepared using K₂CO₃ as a precipitating agent and small amounts of potassium remained in the support even after very extensive washing in boiling water. The samples containing higher proportions of Mg (Ni/K—Mg₅Zr₂ and Ni/K—Mg) retained lower levels of potassium (0.25-1 wt. %) than did samples containing more Zr (Ni/K—Zr and Ni/K—Mg₂Zr₅, 1.2-2.7 wt. %).

XRD measurements showed that the dried materials with only magnesium or an excess of magnesium contained predominantly hydromagnesite (ICDD file no. 08-0179) while those with only zirconia or an excess of zirconia showed predominantly amorphous material (Table 4). The supports calcined at 1073 K contained phases of MgO (ICDD file no.: 78-0430), tetragonal and monoclinic ZrO₂ (ICDD file no.: 88-1007 and 83-0940) and Mg—Zr—O solid solution (ICDD file no.: 24-0712), depending on the composition. Both the monoclinic and tetragonal zirconia phases were observed in the pure zirconia sample; however, for the samples modified with MgO, a MgO/ZrO₂ solid solution (Asencios et al, 2012; Sun et al, 2011; Teterycz et al, 2003; Tian et al, 2011; Trakarnpruk & Sukkaew, 2008) was predominant. No monoclinic phase could be observed but the presence of a tetragonal zirconia phase (t-ZrO₂) could not be excluded in the case of the two materials containing Mg as well as Zr. Gocmez et al. (Gocmez & Fujimori, 2008) synthesized and characterized ZrO₂—MgO by the citrate sol-gel method and showed that their samples after calcination at 1073 K consisted of MgO and a metastable tetragonal ZrO₂ phase, this being consistent with our data.

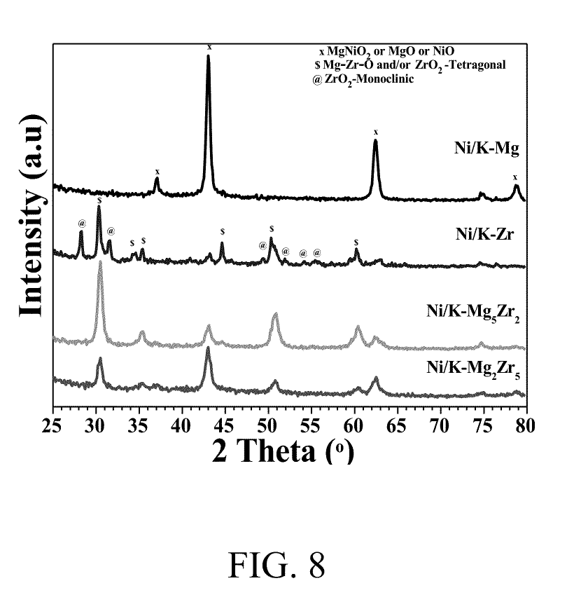

The XRD patterns obtained for the samples containing approximately 10% Ni on the different supports and reduced at 1023 K for 2 h are shown in the supporting information (FIG. 8, ESF^{ψ}) and the results are summarized in the fifth column of Table 3. Any metallic Ni formed in the samples during the reduction stage was re-oxidized by contact with air at room temperature and so no metallic nickel could be detected in the diffractograms. Phases of MgNiO₂ solid solution (ICDD file no.: 24-0712) and/or of trace amounts of NiO (ICDD file no.: 22-1189) with face-centered-cubic structure were present in the Ni/K—Mg, Ni/K—Mg₅Zr₂ and Ni/K—Mg₂Zr₅ samples. Heating of the samples to high temperatures favours diffusion of Ni²⁺ cations into the MgO lattice. Hu and Ruckenstein (Hu & Ruckenstein, 1997) reported that the 2θvalue of MgO is 62.29° while that for NiO is only 0.6° higher, the lattice parameters of the two oxides being very similar; as a result, MgO and NiO can form a range of solid solutions during the calcination and reduction steps. Mg—Zr—O solid solution and/or ZrO₂ in the tetragonal and monoclinic forms were also observed, depending on the composition.

The Ni/K—Mg₅Zr₂ and Ni/K—Mg₂Zr₅ catalysts in the reduced state showed the presence of Mg—Zr—O solid solution (and/or t-ZrO₂), MgO and NiO phases (Table 3). The Ni/K—Zr catalyst contained both the monoclinic and tetragonal phases of ZrO₂; however the Ni/K—Mg₅Zr₂ sample in the reduced form showed peaks due to a MgO/ZrO₂ solid solution (and/or t-ZrO₂) but not to monoclinic zirconia. This indicates that the addition of MgO stabilizes the zirconia in the tetragonal phase or in a MgO/ZrO₂ solid solution. Montoya et al. (Montoya et al, 2000) have suggested that MgO stabilizes t-ZrO₂ by becoming incorporated in the surface vacancies or by covering the ZrO₂ particles, thus preventing contact between the crystallites of t-ZrO₂ and avoiding crystallite growth.

Table 3 also shows the metal surface areas (MSA) and the dispersions (D) of the Ni calculated from the metal areas for the various samples. The Ni/K—Mg₅Zr₂ and Ni/K—Mg samples gave similar metal areas and dispersions (MSA=1.5 and 1.7 m² (g cat)⁻¹; D=2.5 and 2.8%), these being slightly higher than those of the other samples (MSA˜1.2 m² (g cat)⁻¹ and D˜2%); the sample calcined before reduction (Ni/K—Mg₅Zr₂(C)) had a slightly lower MSA and dispersion compared with samples Ni/K—Mg₅Zr₂ and Ni/K—Mg that had been reduced directly. The mean particle sizes of Ni estimated from chemisorption data were found to be 36, 40 nm for the Ni/K—Mg₅Zr₂ and Ni/K—Mg catalysts, respectively. These relatively high values may indicate that a considerable proportion of the nickel is not available for chemisorption as it is involved in the formation of a MgO/NiO solid solution in the bulk of the samples. This was further confirmed by EDS/TEM measurements.

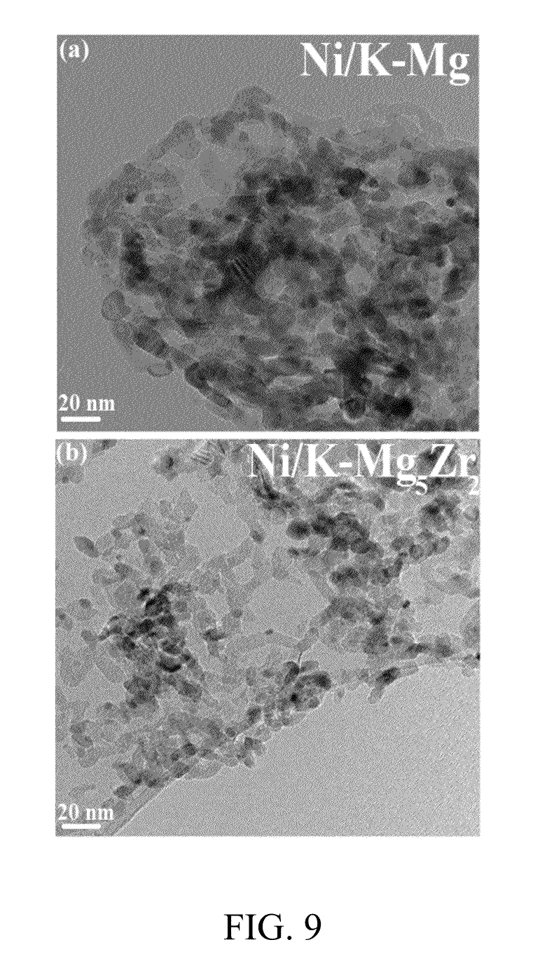

The TEM images of the reduced Ni/K—Mg and Ni/K—Mg₅Zr₂ catalysts (FIG. 9, ESI^{ψ}) show filamentous structures with filaments of less than 20 nm in diameter. NiO particles of about 10 nm size are seen in the Ni/K—Mg sample. The observed size is a factor of 4 lower than the value determined by chemisorption, confirming that a considerable amount of the Ni is not available for chemisorption and that chemisorption cannot be used for the determination of mean Ni particle size for the samples studied. Discrimination of NiO particles in the TEM image in the presence of Zr is complicated.

In order to identify the NiO particles more clearly in the reduced Ni/K—Mg₅Zr₂ catalyst, high angle annular dark-field scanning TEM (HAADF-STEM) images of the sample as well as the corresponding EDS maps were obtained. FIG. 1a shows a typical scanning TEM region and FIG. 1b shows the corresponding EDX Ni map. The EDX results indicate the presence of two forms of the Ni particles with a size of less than 10 nm, indicated with arrows, and more highly dispersed (probably atomically dispersed) Ni that may be located in the bulk in the form of a MgO/NiO solid solution in accordance with the XRD and chemisorption data.

XPS was used to determine the composition of the surface layer. The most important feature of the XPS results described in ESI^{ψ} was that the atomic ratio of the surface concentrations of Zr to Mg was very low −0.03 (Table 5). This indicates that magnesia covers a phase either composed of t-ZrO₂ and/or a MgO/ZrO₂ solid solution of the type determined by XRD. Thus, we can conclude that the surface of the support in this sample is quite similar to that of pure MgO. We have previously reported similar XPS results for other Ni/MgO—ZrO₂ samples (Nagaraja et al, 2011).

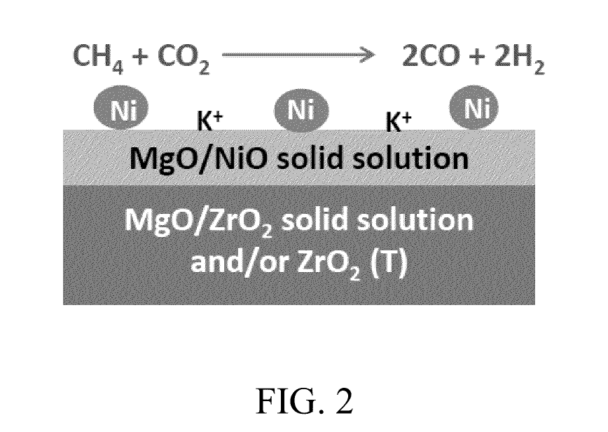

Summarizing the characterization results for the Ni/MgO—ZrO₂ samples, a schematic representation of the catalyst structure is shown in FIG. 2. Under the conditions of the dry reforming reaction (i.e reducing conditions), the Ni is present on the surface of the support in the form of metallic particles of diameter about 10 nm or less. The surface layer of the catalyst support itself is probably composed of a MgO/NiO solid solution doped by potassium ions. The MgO/NiO layer is located over a MgO/ZrO₂ solid solution and/or t-ZrO₂. Such a core makes the catalyst mechanically stable as compared to pure MgO. The catalytic results obtained with these samples will now be presented and these will be discussed in relation to this model of the catalyst.

### Example 6

### Catalytic Activity and Carbon Deposition Results

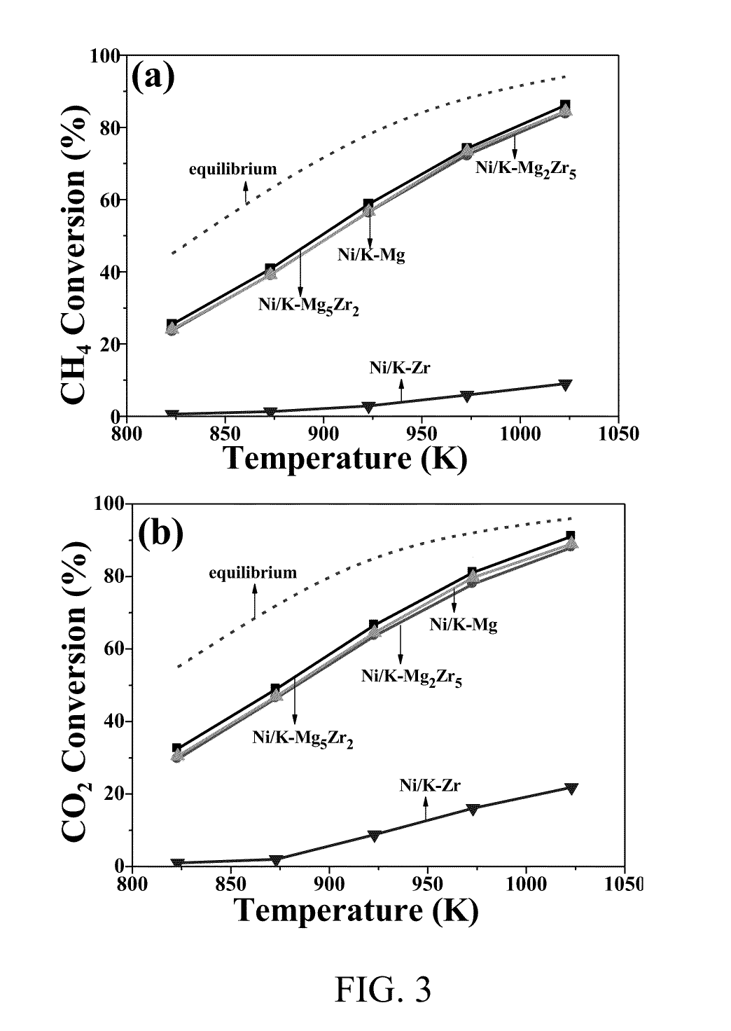

The CH₄ and CO₂ conversions for all the Ni-containing samples as a function of reaction temperature in the range 823-1023 K are shown in FIG. 3. The methane conversions obtained with the Ni/K—Mg, Ni/K—Mg₅Zr₂ and Ni/K—Mg₂Zr₅ catalysts were high and were relatively indistinguishable. The values were lower than the calculated equilibrium values for the conditions used and reached 85% for CH₄ and 91% for CO₂ at the uppermost temperature tested, 1023 K, the H₂/CO ratio in the products being 0.97; the corresponding equilibrium conversions of CH₄ and CO₂ were calculated to be 94% and 96%, respectively. The conversions obtained with the Ni—Zr catalyst at 1023 K were much lower than those for the other samples, the highest CH₄ and CO₂ conversions being 13 and 19%, respectively. The H₂/CO ratio for this sample was 0.4, this being lower than the stoichiometric value as a result of the reverse water gas shift reaction.

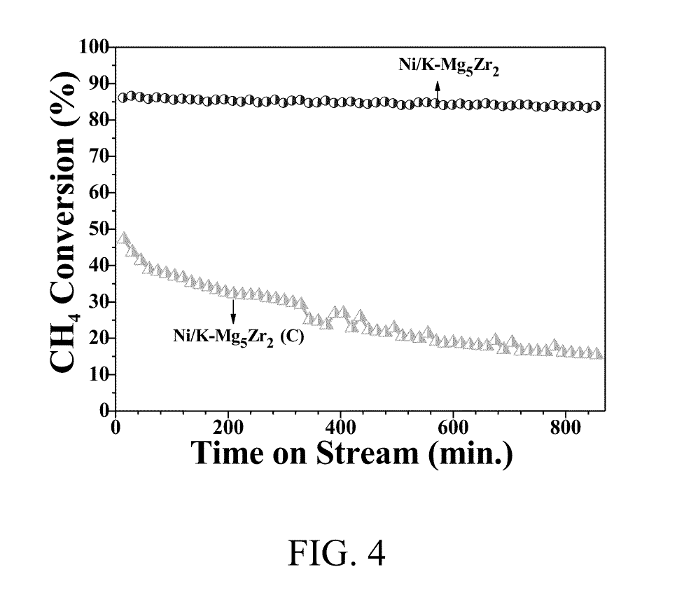

FIG. 4 shows the time-dependent methane conversions at 1023 K measured for the reduced Ni/K—Mg₅Zr₂ sample with and without pre-calcination in air. The activity of the uncalcined sample Ni/K—Mg₅Zr₂ was very stable over a period of operation of 14 h. In contrast, the calcined sample, Ni/K—Mg₅Zr₂ (C), had a lower activity and also deactivated rapidly with time on stream, giving a decrease in CH₄ conversion from 47% to 15%. The significant difference in catalytic activities of the samples is consistent with the hydrogen chemisorption results: the metal surface area and the dispersion of the precalcined sample were significantly lower compared with those of the directly reduced Ni/K—Mg₅Zr₂ catalyst (see Table 3). The fact that reduction without calcination gave better results than did pre-calcination at 1073 K indicates that a MgO/NiO solid solution is probably formed in higher concentration when the oxides are heated to 1073 K in air; in contrast, direct reduction of the dried material gives rise to the formation of nickel crystallites before any solid-state reaction to give a MgO/NiO solid solution can occur.

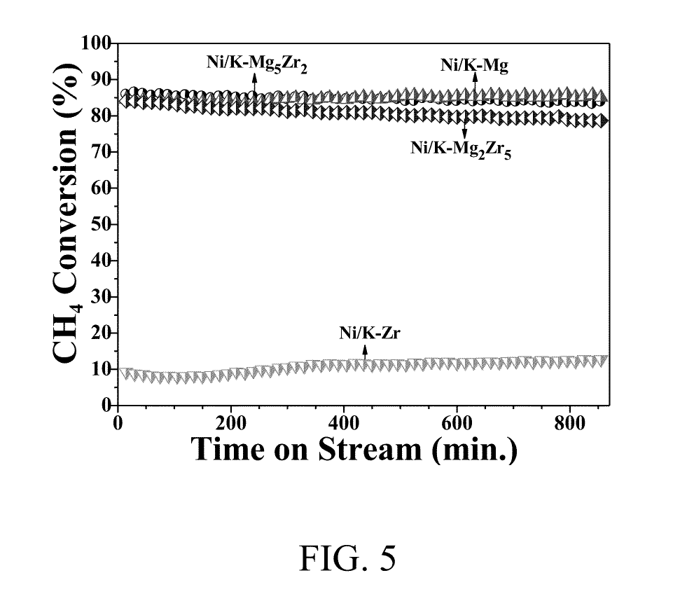

FIG. 5 shows the time-dependent catalytic performances at 1023 K of the samples of Table 1 that had not been calcined. The Ni/K—Mg and Ni/K—Mg₅Zr₂ materials showed stable conversions as a function of time over a period of reaction of 14 h. In contrast, the Ni/K—Mg₂Zr₅ material deactivated slightly with time on stream, giving a decrease in the CH₄ conversion from 84% to 78%. The Ni/K—Zr sample, however, gave very low conversions (12%) compared with those of the other three samples although there was a slight increase in conversion with time on stream. After 14 h on stream, the trend of the CH₄ conversions was as follows: Ni/K—Mg˜Ni/K—Mg₅Zr₂>Ni/K—Mg₂Zr₅>>Ni/K—Zr.

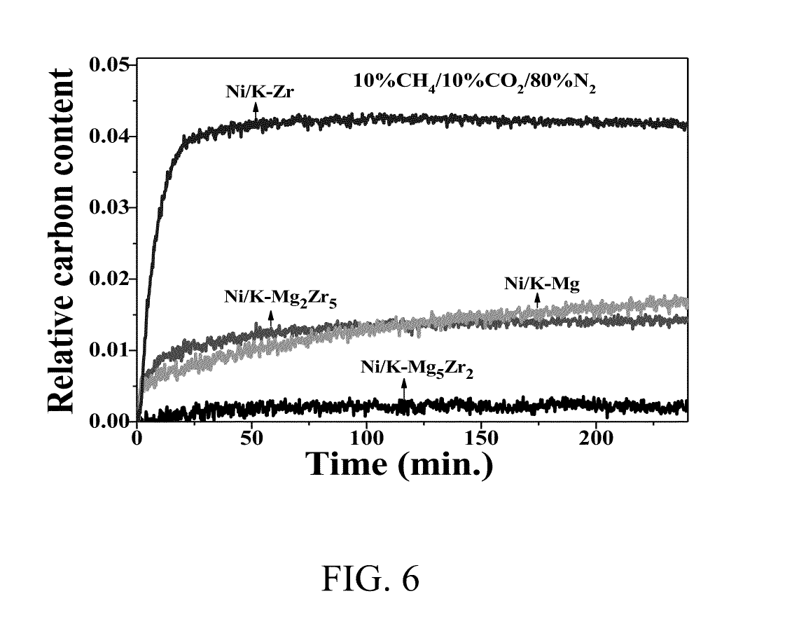

The stability of the catalysts studied can be closely related with their resistance to carbon deposition. To check whether or not there was significant coke deposition on our catalysts, experiments were performed in the IGA system in which the weight of the sample was measured as a function of reaction time. FIG. 6 shows the results of the IGA experiments carried out at 1023 K for the four different samples. The level of carbon deposition for all the Zr-containing samples reached a steady-state value within 100 min of reaction. It is significant that only a very low level of carbon deposition was found for the Ni/K—Mg₅Zr₂ sample over a period of 4 h at 1023 K. In contrast, the Ni/K—Zr sample gave a significant level of carbon deposition while the Ni/K—Mg and Ni/K—Mg₂Zr₅ samples both gave intermediate levels of carbon deposition. It is worth noting (see FIG. 5) that the sample without added Mg, Ni/K—Zr, had a very stable activity at 1023 K but that it gave very low CH₄ conversion (12%) compared with the other samples. This low conversion is possibly partially due to the fact that it exhibited the highest level of carbon deposition. It should be noted that the metal surface area and Ni dispersion of this catalyst were lower than those for the Ni/K—Mg₅Zr₂ and Ni/K—Mg catalysts (see Table 3). Generally, the trend in the magnitudes of carbon deposition during the dry reforming reaction was as follows: Ni/K—Zr>Ni/K—Mg˜Ni/K—Mg₂Zr₅>Ni/K—Mg₅Zr₂.

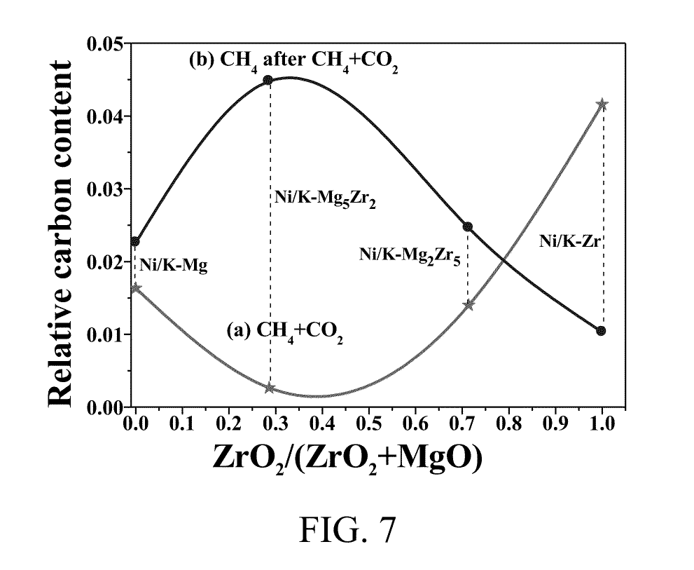

Each of the experiments carried out with a CH₄/CO₂/N₂ mixture shown in FIG. 6 was followed by switching the reactant gas to a CH₄/N₂ mixture for 1 h. FIG. 7 compares the relative carbon contents of each of the catalysts before and after this additional reaction period. It can be seen that the catalysts giving the highest carbon deposition levels in the CH₄/CO₂ reaction gave the lowest levels after the reaction in CH₄ alone. For example, a small amount of carbon deposition was found for the Ni/K—Mg₅Zr₂ catalyst in a CH₄/CO₂ mixture (FIG. 7) but a very large increase of the carbon content was observed for this catalyst in CH₄ in the absence of CO₂. This seems to indicate that carbon can be deposited rapidly from CH₄; however, in the presence of CO₂, it can be removed effectively by the CO₂, this resulting in negligible values of the steady-state carbon content.

It is well established that the nature of the support strongly affects the level of carbon deposition. It has been suggested that carbon deposition can be attenuated or even suppressed when the metal is supported on a metal oxide having a strong Lewis basicity (Horiuchi et al, 1996; Zhang & Verykios, 1994). For example, Hu and Ruckenstein. have reported that MgO is a very effective support for metal catalysts, suppressing carbon deposition in the reforming of methane with CO₂ (Hu & Ruckenstein, 1997). Their Ni/MgO catalyst demonstrated stable activity for 60 hours at 1063 K. Several authors have noted a relationship between the particle size of the active metal and the amount of carbon deposited on the surface of the support (Hu & Ruckenstein, 1997; Kim et al, 2000). Juan-Juan et al. (Juan-Juan et al, 2009) reported that not only does the particle size determine the level of carbon deposition but that other factors such as particle morphology, structure and pre-treatment all have an effect. The best catalysts studied in the present work showed very low rates of carbon deposition (FIG. 6) and very high stability in the dry reforming of methane (FIG. 5). This can be a result of the presence of Ni in a highly dispersed state and of the high basicity of the surface of the support, these being related to the presence of a MgO/NiO layer doped with K ions (FIG. 2). A number of investigators have reported that the reducibility of NiO in such materials depends on the composition of the MgO/NiO solid solution and on the structure of MgO, as well as on the calcination temperature and duration of the preparation of the solid solution (Bond & Sarsam, 1988; Borowiecki, 1984; Parmaliana et al, 1990).

The relatively high surface area of the samples studied here led to high dispersion of the Ni and these highly dispersed Ni particles may activate the methane effectively. However, as proposed by Snoeck et al. (Snoeck et al, 2002), it cannot be excluded that the K ions can be located partially on the Ni surface, this leading to a decrease of the number of Ni sites available for the methane decomposition step. The MgO/NiO surface layer doped with K ions may activate CO₂ effectively, thus providing CO and adsorbed oxygen species for gasification of carbon species. Hence, the presence of K ions is important.

Kiennemann and his group (Koubaissy et al, 2010; Pietraszek et al, 2011) have recently reported the catalytic properties for the dry reforming of methane of samples with the composition 5 wt. % Ni/CeZr oxide that were doped with 0.5 wt. % of Rh or Ru. The conditions of their measurements (temperature, composition, flow rate) were similar to those used in this work, with the exception that a higher catalyst charge (a factor of five greater) was used. These authors reported that their undoped Ni/CeZr oxide catalysts deactivated significantly. However, they found that doping with the noble metals imparted stable activities and that the doped Ni/CeZr oxide catalysts gave almost equilibrium conversions of CH₄ and CO₂. Comparing their results with those of the present work, the lower weights (20 mg) of of our samples gave quite similar conversions, selectivities and stabilities for the dry reforming reaction to those reported by Keinnemann et al. (Koubaissy et al, 2010; Pietraszek et al, 2011). The advantage of the samples reported here was that there was no need to dope with the expensive noble metals.

### Example 7

### Conclusions Regarding the Catalyst Samples Prepared in Example 1

A stable and selective Ni/K—Mg₅Zr₂ catalyst that is resistant to carbon deposition has been developed for the dry reforming of methane. The K-doped Ni/MgO—ZrO₂ catalysts studied in the present work demonstrate a high surface area, a high stability in the reaction and a good resistance to coke deposition. Reduction of the Ni precursor in hydrogen without prior calcination of the samples has been shown to be necessary for the best catalytic performance and this procedure appears to give rise to highly dispersed Ni particles (<10 nm) on the support that activate the methane in the reaction. Calcination of a sample at 1073 K before reduction leads to a catalyst that deactivates rapidly. This calcination step appears to decrease the amount of active nickel on the surface by sintering of the Ni particles and by incorporation of Ni²⁺ into the bulk of an MgO layer, hence forming a solid solution. As confirmed by XPS, XRD and EDS/STEM, the Ni/K—Mg₅Zr₂ and Ni/K—Mg catalysts studied exhibited the formation of a MgO/NiO solid solution doped by K ions. This solid solution activates carbon dioxide. The MgO/NiO layer is formed on top of either a tetragonal ZrO₂ and/or a MgO/ZrO₂ solid solution. Addition of ZrO₂ to MgO may also lead to a more mechanically stable support compared to the unpromoted MgO.

TABLE 3
Physico-chemical characteristics of the Ni catalysts prepared on the different
supports. The Ni metal surface areas and dispersions were calculated from the H₂
chemisorption data. All the samples other than that with (C) were reduced without
prior calcination; the sample labeled (C) was calcined at 1073 K before reduction.

| | Ni | K⁺ | S_{BET} of | | Metal | Metal- |
|---|---|---|---|---|---|---|
| | con- | con- | reduced | Phases detected in | surface | lic dis- |
| | tent/ | tent/ | samples/m² | reduced samples | area/m² | persion/ |
| Catalysts | wt % | wt % | (g cat)⁻¹ | by XRD | (g cat⁾⁻¹ | % |
| Ni/K—Mg₅Zr₂ | 9.1 | 0.95 | 59 | Mg—Zr—O and/or ZrO₂ | 1.7 | 2.8 |
| | | | | (T), MgNiO₂ | | |
| Ni/K—Mg₂Zr₅ | 10 | 1.27 | 34 | Mg—Zr—O and/or ZrO₂ | 1.2 | 1.8 |
| | | | | (T), MgNiO₂ | | |
| Ni/K—Mg | 9 | 0.26 | 75 | MgNiO₂ | 1.5 | 2.5 |
| Ni/K—Zr | 8.9 | 2.71 | 4 | NiO, ZrO₂ (M & T) | 1.17 | 2.0 |
| Ni/K—Mg₅Zr₂(C) | 9.1 | 0.95 | 42 | Mg—Zr—O and/or ZrO₂ | 1.24 | 2.0 |
| | | | | (T), MgNiO₂ | | |

M—Monoclinic,
T—Tetragonal

### Example 8

### Additional Data on the Catalysts of Example 1

The supported nickel catalysts were prepared by impregnation of the various supports using solutions of nickel nitrate; the final content of reduced nickel was about 10 wt. %.

Powder X-ray diffraction (XRD) patterns were measured on a Philips X'Pert PRO MPD system equipped with a rotating anode and using Ni-filtered Cu Kα radiation (λ=1.5418 Å).

TABLE 4
Phase composition of the dried and calcined
supports from X-ray diffraction studies.

| | XRD Phases | |
|---|---|---|
| Supports | Dried | Calcined |
| K—Zr | Amorphous | ZrO₂ (Monoclinic & Tetragonal) |
| K—Mg | Hydromagnesite | MgO |
| K—Mg₅Zr₂ | Hydromagnesite | MgO, Mg—Zr—O and/or ZrO₂- |
| | | Tetragonal |
| K—Mg₂Zr₅ | Amorphous | MgO, Mg—Zr—O and/or ZrO₂ - |
| | | Tetragonal |

The XRD patterns obtained for the samples containing approximately 10% Ni on the different supports and reduced at 1023 K for 2 h are shown in FIG. 8.

The TEM images of the reduced (Ni/K—Mg and Ni/K—Mg₅Zr₂, 1023K for 2 h) catalysts were taken with a JEOL JEM-2100F (200 kV) microscope are shown in FIG. 9.

The X-ray photoelectron spectroscopy (XPS) studies were performed with a Kratos Axis 165 spectrometer using monochromatic Al Kα radiation (λv=1486.58 eV) and a fixed analyzer pass energy of 20 eV.

TABLE 5
X-ray Photo-electron Spectroscopy Results
for the reduced Ni/K—Mg₅Zr₂ catalyst.

| Binding energy | Position, | Atomic surface ratio |
|---|---|---|
| region | eV | relative to Mg²⁺ |
| Mg 2s | 88.0 | 1 |
| Ni 2p_{3/2}, Ni 2p_{1/2} | 855.2, 861.1 | 0.01 |
| Zr 3d_{5/2}, Zr 3d_{3/2} | 181.8, 184.1 | 0.03 |
| K 2p_{3/2} | 292.6 | 0.004 |
| O 1s | 529.5-533.0 | — |

The reduced Ni/K—Mg₅Zr₂ catalyst was examined using X-ray photoelectron spectroscopy with the aim of obtaining information about the electronic state of the Ni and the chemical composition of the sample surface. The data obtained from analysis of the spectra (Ni 2p, Mg 2s, Zr 3d, O 1s and K 2s species) are shown in Table 5. The XPS pattern of the Ni in the catalyst contains two maxima, one at 855.2 and the other at 861.1 eV, both being characteristic of Ni²⁺ compounds; no other peaks were observed. Hence, there was no evidence of the presence of metallic Ni; however, as discussed in the main text, this was most likely due to the sample being oxidized by oxygen of the air during the transfer to the XPS chamber. The two peaks of Zr 3d observed correspond to the Zr 3d_{5/2} (181.8 eV) and Zr 3d_{3/2} (184.1 eV) transitions, these being assigned to the Zr⁴⁺ state (Tsunekawa et al, 2005). The peak for Mg 2s occurred at 88.0 eV, this being characteristic of Mg²⁺. The O 1s spectrum of the Ni—Mg₅Zr₂ sample had three components, at 529.5, 531.3 and 533.0 eV; these may arise from either lattice oxygen or from hydroxyl/carbonate groups.

An important feature of the XPS results was that the atomic ratios of the surface concentrations of Zr to Mg were very low −0.03 (Table 5). This indicates that magnesia covers a phase either composed of tetragonal zirconia or a MgO/ZrO₂ solid solution. Thus, we can conclude that the surface of the support in this sample is quite similar to that of pure MgO. Similar results were obtained for other samples (Nagaraja et al, 2011). Cationic potassium was also found on the sample surface and this is in accord with the AAS data (Table 3). The atomic surface ratio of the K relative to Mg was 0.004 (Table 5).

We claim:

1. A process for preparing a catalyst comprising the steps of:
(a) dissolving water soluble salts of magnesium in water
(b) adding a basic solution of an alkali metal or a salt of an alkali metal to the dissolved magnesium salt of step (a) to generate a precipitate;
(c) washing the precipitate;
(d) drying the precipitate;
(e) calcining the precipitate;
(f) impregnating the precipitate with an aqueous solution of a dissolved nickel salt
(g) drying the nickel-impregnated precipitate

2. A process according to claim 1 wherein the salt of step (a) comprises magnesium nitrate.

3. A process according to claim 2 wherein the basic solution of step (b) comprises potassium carbonate.

4. A process according to claim 3 wherein the amount of Ni in the final catalyst is, by weight percentage, between 2% and 50%.

5. A catalyst prepared by the process of claim 1.

6. A catalyst prepared by the process of claim 2.

7. A catalyst prepared by the process of claim 3.

8. A catalyst prepared by the process of claim 3.

9. A process for preparing a catalyst comprising the steps of:
(a) dissolving water soluble salts of magnesium and water soluble salts of zirconium in water
(b) adding a basic solution of an alkali metal or a salt of an alkali metal to the dissolved magnesium salt and zirconium salt of step (a) to generate a precipitate;
(c) washing the precipitate;
(d) drying the precipitate;
(e) calcining the precipitate;
(f) impregnating the precipitate with an aqueous solution of a dissolved nickel salt
(g) drying the nickel-impregnated precipitate

10. A process according to claim 9 wherein the salts of step (a) comprise magnesium nitrate and zirconium nitrate.

11. A process according to claim 10 wherein the basic solution of step (b) comprises potassium carbonate.

12. A process according to claim 11 wherein the amount of Ni in the final catalyst is, by weight percentage, between 2% and 50%.

13. A catalyst prepared by the process of claim 9.

14. A catalyst prepared by the process of claim 10.

15. A catalyst prepared by the process of claim 11.

16. A catalyst prepared by the process of claim 12.

17. A process for preparing a catalyst comprising the steps of:
(a) dissolving water soluble salts of magnesium, zirconium, and an alkali metal in metal
(b) adding a basic solution to the dissolved magnesium, zirconium, and alkali metal salts of step (a) to generate a precipitate;
(c) washing the precipitate;
(d) drying the precipitate;
(e) calcining the precipitate;
(f) impregnating the precipitate with an aqueous solution of a dissolved nickel salt
(g) drying the nickel-impregnated precipitate

18. A process according to claim 17 wherein the salts of step (a) comprises magnesium nitrate, zirconium nitrate, and potassium nitrate.

19. A process according to claim 18 wherein the basic solution of step (b) comprises one or more of dissolved reagents selected from the group consisting of sodium carbonate, sodium bicarbonate, sodium oxalate, sodium hydroxide, potassium carbonate, potassium bicarbonate, potassium oxalate, potassium hydroxide, lithium carbonate, lithium bicarbonate, lithium oxalate, lithium hydroxide, ammonium carbonate, ammonium bicarbonate, and ammonia.

20. A process according to claim 19 wherein the amount of Ni in the final catalyst is, by weight percentage, between 2% and 50%.

21. A catalyst prepared by the process of claim 17.

22. A catalyst prepared by the process of claim 18.

23. A catalyst prepared by the process of claim 19.

24. A catalyst prepared by the process of claim 20.
